(19) United States
(12) Patent Application Publication
(10) Pub. No.: US 2011/0078877 A1
(43) Pub. Date: Apr. 7, 2011

(54) Extensible Handle for a Cart

(75) Inventor: TOBIN RISNER, San Luis Obispo, CA (US)

(73) Assignee: Tobin Risner, San Luis Obispo, CA (US)

(21) Appl. No.: 12/574,535

(22) Filed: Oct. 6, 2009

(51) Int. Cl. B25G 1/04

(52) U.S. Cl. 16/429

(57) ABSTRACT

An extensible handle formed from an L-shaped tubular member having a generally arcuate elbow. The extensible handle is coupled to a wheeled cart with a clamping assembly. The clamping assembly includes first and second individual clamping members disposed in a side-by-side relationship at opposing ends of the main body. The first clamping member includes a first aperture formed from opposing hemispherical walls of the main body and is dimensioned to axially receive the L-shaped tubular member therethrough. The second clamping member includes a second aperture formed by a pair of split opposing walls of the main body and is dimensioned to axially receive a longitudinal section of a cart member therethrough. The first and second clamping members are configured to compressively engage longitudinal sections of tubular members passing through their respective apertures by reduction in cross-sectional areas of the apertures

### CROSS-REFERENCE TO RELATED APPLICATIONS

Not applicable

### RELEVANT FIELD

This application is directed generally toward handles and more specifically toward extensible handles for manually powered carts.

### BACKGROUND

Various carts are known in the relevant art which require a user to provide propulsion by pushing or pulling of the carts. In many situations, the handles provided with the carts are limited to fixed geometries. These fixed geometries may be suitable for short term propulsion of the carts. However, extended user propulsion may lead to a variety of ailments such as musculoskeletal pains, muscle sprains and/or aggravation of congenital deformities of the spine. Even when these fixed propulsion geometries do not materially impact the wellbeing of the user, there still may exist mobility and portability issues which are undesirable, particularly for those involved in an active lifestyle in which the cart needs to be transported in a motor vehicle. Accordingly, there is a need in the relevant art to address the fixed geometries provided with carts.

### SUMMARY

In view of the foregoing, various exemplary embodiments of an extensible handle suitable for use with any small vehicle pushed or pulled by hand hereinafter described as a cart. The extensible handle(s) described herein do not materially increase the storage volume or weight of the cart; may be adjusted to suit almost any commonly encountered geometry; adaptable for original equipment or for retrofit purposes. In an exemplary embodiment, the extensible handle includes an L-shaped tubular member having a generally arcuate elbow. A clamping assembly is provided for coupling the extensible handle to a cart. The clamping assembly includes a main body, first and second individual clamping members disposed in a side-by-side relationship at opposing ends of the main body. The first clamping member includes a first aperture formed from opposing hemispherical walls of the clamping assembly's main body and is configured to compressively engage an outer circumferential wall of the L-shaped tubular member by reduction of a cross-sectional area of the first aperture.

The second clamping member includes a second aperture formed by a pair of split opposing walls of the main body. The second aperture is dimensioned to axially receive a longitudinal section of a cart member therethrough and configured to compressively engage the longitudinal section of the cart member by reduction in a cross-sectional area of the second aperture encompassing the longitudinal section of the cart member.

In an exemplary embodiment, a hand bolt is rotationally engaged with the opposing hemispherical walls of the main body and configured to reduce the cross-sectional area of the first aperture by manual tightening of the hand bolt. This engagement compresses the hemispherical walls against the L-shaped tubular member thus locking the L-shaped tubular member in a desired position.

In an exemplary embodiment, the hand bolt engages the first clamping member at an oblique angle relative to the main body of the clamping assembly.

In an exemplary embodiment, one of the split opposing walls of the main body is configured as clamp cap separate from the main body and attachable to the main body with at least one fastener.

In an exemplary embodiment, the L-shaped tubular member includes a handle section and a positioning section. In this exemplary embodiment, the handle section is encompassed in a padding material. In another exemplary embodiment, the positioning section includes index markings. In another exemplary embodiment, the positioning section includes an end of travel stop.

In various exemplary embodiments, the L-shaped tubular member is axially and/or longitudinally repositionable with the first clamping member.

In another exemplary embodiment, the first clamping member is generally C-shaped. In another exemplary embodiment, compressing means is provided for reducing the cross-sectional area of the first aperture. In a related exemplary embodiment, the compressing means may be a hand bolt or a lever assembly.

In an exemplary embodiment, a pivotal axle is provided with main body. The pivotal axle being configured to pivot at oblique angles relative to the longitudinal section of a cart member.

Other exemplary embodiments include addition(s) of an odometer and/or a heart rate monitor. The heart rate monitor embodiments may be incorporated into grips associated with the handle section.

### BRIEF DESCRIPTION OF DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments as is defined by the claims.

FIG. 1—depicts an exploded prospective view of an extensible handle in accordance with an exemplary embodiment.

FIG. 1A—depicts an assembled prospective view of an extensible handle in accordance with an exemplary embodiment.

FIG. 2—depicts a side view of a clamping assembly in accordance with an exemplary embodiment.

FIG. 3—depicts a perspective view of an extensible handle attached to a cart in accordance with an exemplary embodiment.

FIG. 3A—depicts a close-up perspective view of an extensible handle attached to a cart in accordance with an exemplary embodiment.

FIG. 4—depicts an exploded prospective view of an extensible handle in accordance with an exemplary embodiment.

FIG. 4A—depicts an assembled prospective view of an extensible handle in accordance with an exemplary embodiment.

FIG. 5—depicts a perspective view of an extensible handle attached to a cart in accordance with an exemplary embodiment.

FIG. 5A—depicts a close-up perspective view of an extensible handle attached to a cart in accordance with an exemplary embodiment.

### DETAILED DESCRIPTION

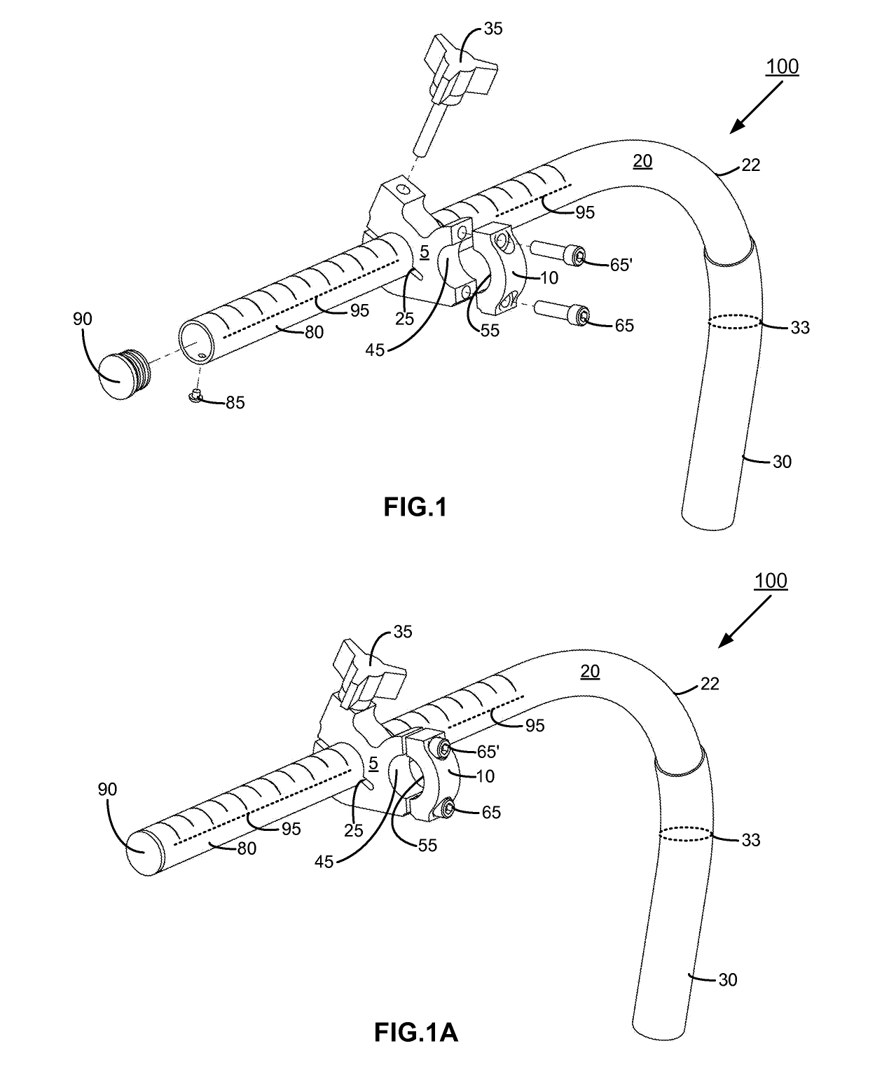

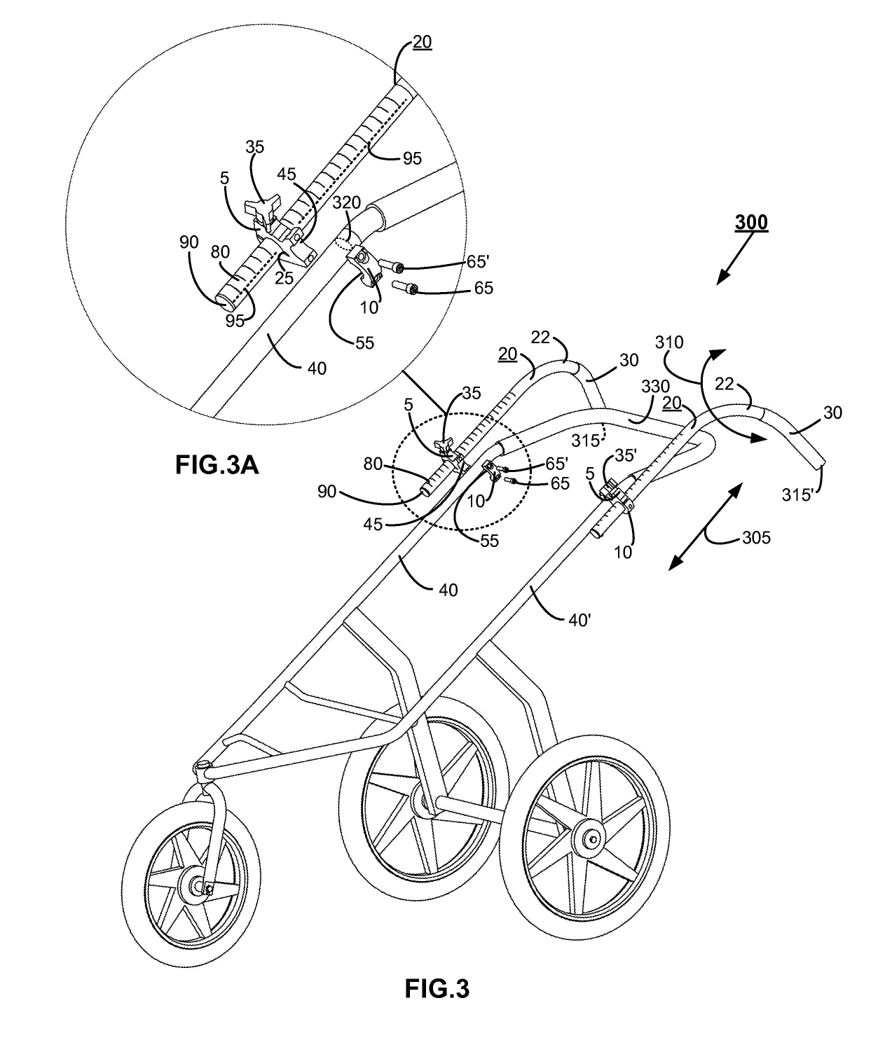

Various exemplary embodiments of an extensible handle for a cart are disclosed herein. In the following exemplary description, numerous specific details are set forth in order to provide a thorough understanding of the present inventive embodiments. It will be apparent, however, to one skilled in the art that the present inventive embodiments may be practiced without these specific details. In other instances, well-known structures and devices may be shown in block diagram form in order to avoid unnecessarily obscuring the present inventive embodiments. Referring to FIG. 1, an exploded prospective view of an extensible handle 100 in accordance with an exemplary embodiment is depicted. The extensible handle 100 comprises a generally L-shaped tubular member 20. The L-shaped tubular member 20 encompasses a generally arcuate elbow 22, a handle section 30 and a positioning section 80. The handle section 30 encompasses the portion of the L-shaped tubular member 20 in which a user contacts to propel a cart 300 (FIG. 3). Padding 33 may be provided over the handle section 30 of the L-shaped tubular member 20 for comfort of the user when propelling the cart 300 (FIG. 3). The padding 33 may be constructed from a polymeric foam or any other suitable grip material.

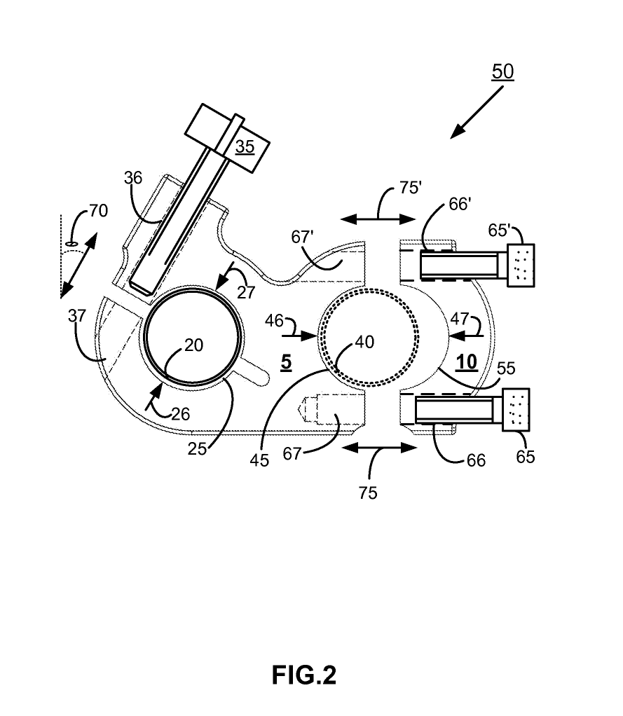

The positioning section 80 includes the portion of the L-shaped tubular member 20 which is slidably disposed within a main body 5 of a clamping assembly 50 (FIG. 2). The L-shaped tubular member 20 may include index markings 95 along a longitudinal dimension of the positioning section 80 to simplify repeating a desired geometry of the L-shaped tubular member 20. An end cap 90 may be provided at the distal end of the positioning section 80. An end of travel stop 85 may likewise be provided proximate to the end cap 90 in order to prevent pulling of the L-shaped tubular member 20 from the main body 5 of the clamping assembly 50 (FIG. 2). The clamping assembly 50 (FIG. 2) is described in detail in the discussion accompanying FIG. 2 below. In general, one end of the clamping assembly 50 (FIG. 2) is configured to axially engage the L-shaped tubular member 20 and maintain a desired geometry comfortable to the user. A contralateral end of the clamping assembly 50 (FIG. 2) is used to axially engage a longitudinal section 40 (FIG. 3) of the cart 300 (FIG. 3). FIG. 1A depicts an assembled prospective view of the extensible handle 100 in accordance with an exemplary embodiment. In this exemplary embodiment, the longitudinal dimension of the positioning section 80 is compressively held in position by the clamping assembly 50 (FIG. 2). The L-shaped tubular member 20 may be constructed from any light weight and durable material, preferably aluminum alloy or steel tubing. High strength polymeric materials, such as carbon fiber or fiberglass composite based materials may be used as well.

Referring to FIG. 2, a side view of a clamping assembly 50 in accordance with an exemplary embodiment is depicted. In this exemplary embodiment, the clamping assembly 50 comprises a main body 5 and first 26, 27 and second individual clamping members 46, 47 disposed in a side-by-side relationship at opposing ends of the main body 5. The first clamping member 26, 27 includes a first aperture 25 provided through a predominate face of the main body 5. The first aperture 25 is dimensioned to axially receive the tubular the L-shaped tubular member 20. Opposing hemispherical walls 26, 27 which form the aperture 25 are configured to compressively engage an outer circumferential wall of the L-shaped tubular member 20 by reduction in a cross-sectional area of the first aperture 25. In this exemplary embodiment, compression of the opposing hemispherical walls 26, 27 is accomplished by tightening of a threaded hand bolt 35. The threaded hand bolt 35 is inserted through an elongated aperture 36 disposed on one side of the first aperture 25 and axially threaded into an threaded aperture 37 disposed on an opposing side of the first aperture 25. In an exemplary embodiment, the hand bolt 35 engages the main body 5 at an oblique angle 70 which positions the head portion of the hand bolt 35 in a convenient location for engagement by the user. In an exemplary embodiment, the first clamping member 26, 27 is configured with a generally C-shaped side profile which substantially encompasses the L-shaped tubular member 20 when axially disposed therethrough. The irregular profile of the main body 5 is provided to allow the oblique engagement angle 70 of the hand bolt 35 with the main body 5.

The second clamping member 46, 47 includes a second aperture 45, 55 formed by a pair of split opposing walls 46, 47 of the main body 5 and an opposing separate clamp cap 10. The second aperture 45, 55 is dimensioned to axially receive a longitudinal section of a cart member 40 therethrough. The clamp cap 10 includes a pair of contralateral apertures 66, 66′ dimensioned to laterally 75, 75′ receive a pair of retaining bolts 65, 65′ therethrough. The retaining bolts 65, 65′ are threaded into contralateral threaded apertures 67, 67′ aligned perpendicular to the axially received longitudinal section of the cart member 40. Tightening of the retaining bolts 65, 65′ compressively engages the longitudinal section of the cart member 40 by reduction in a cross-sectional area of the second aperture 45, 55 encompassing the longitudinal section of the cart member 40. The clamping assembly 50 may be constructed from any suitable material, preferably a lightweight metal such as aluminum alloys.

The clamping assembly 50 may be machined from a solid aluminum alloy block or cast from a mold. Suitable aluminum alloys include aircraft grades T6061, T6062 or T6063. Alternately, a durable high impact polymeric material may used as well for the main body 5 of the clamping assembly 50. In such implementations, the apertures 36, 37, 66, 66′, 67, 67 which receive threaded bolts 35, 65, 65′ may be reinforced with threaded metal inserts. Traditional machining methods known in the relevant art may be used to generate the various apertures and cuts of the clamping assembly 50.

Referring to FIG. 3, a perspective view of an extensible handle 100 (FIG. 1A) attached to a cart 300 in accordance with an exemplary embodiment is depicted. In this exemplary embodiment, a frame for a typical three-wheeled cart 300 commonly employed for jogging strollers is shown. However, the inventive concepts described herein may be used to address other similarly arranged carts. By way of example and not limitation, strollers, hand trucks, and/or lawn mowers. In a typical installation, a pair of extensible handles 100 (FIG. 1A) are shown attached to contralateral longitudinal sections of the cart members 40, 40′. Once attached to the longitudinal sections of the cart members 40, 40′, the longitudinal dimension 305 and/or axial positions 310 of the handle portions 30, 30′ of the extensible handles 100 may be adjusted by simply loosening the hand bolts 35, 35′ and positioning of the extensible handles 100 in a comfortable geometry for the user. Once a comfortable axial 310 and/or longitudinal positioning 305 geometry has been established, the hand bolts 35, 35′ are tightened, thus locking the extensible handles 100 into the comfortable geometry. By way of example and not limitation, the handle sections 30, 30′ may oriented such that the ends 315, 315′ of the handle sections 30, 30′ point inward in contralateral opposition to minimize the cross section of the extensible handles 100 attached to the cart 300; upward to allow a taller individual to push the cart 300 without having to bend over; downward to allow a shorter individual to push the cart 300 without having to reach upward at an awkward angle; or laterally outward to establish a wide grip for gaining a greater mechanical advantage when pushing the cart 300 up an incline.

Referring to FIG. 3A, a close-up perspective view of an extensible handle 100 (FIG. 1A) attached to a cart 300 in accordance with an exemplary embodiment is depicted. In this exemplary embodiment, to attach the extensible handle 100 to a cart member 40, the clamp cap 10 is disposed on one side of the cart member 40 with the hemispherical wall 55 which forms one-half of the second aperture 45 (FIG. 2) aligned with the complementary outer circumferential surface of the cart member 40. The main body 5 of the clamping assembly 50 (FIG. 2) is likewise positioned such that the remaining half of the second aperture 45 (FIG. 2) is aligned with the complementary outer circumferential surface of the cart member 40 in a parallel relationship with the clamp cap 10. The pair of retaining bolts 65, 65′ are then inserted into their respective apertures 66, 66′, 67, 67′ and tightened so as to circumferentially clamp the main body 5 of the clamping assembly 50 (FIG. 2) to the cart member 40 (FIG. 3). Typically, the extensible handle 100 is attached to the cart member 40 at a position 320 proximal to an existing handle 330 (FIG. 3) but before a change in linear alignment. This process is repeated for an complementary extensible handle 100 to be attached to a second cart member 40′ (FIG. 3). Once the extensible handles 100 (FIG. 1A) are attached to the cart 300, the user then adjusts the extensible handles 100 (FIG. 1A) for comfortable axial 310 and/or longitudinal positioning 305 geometry as described above.

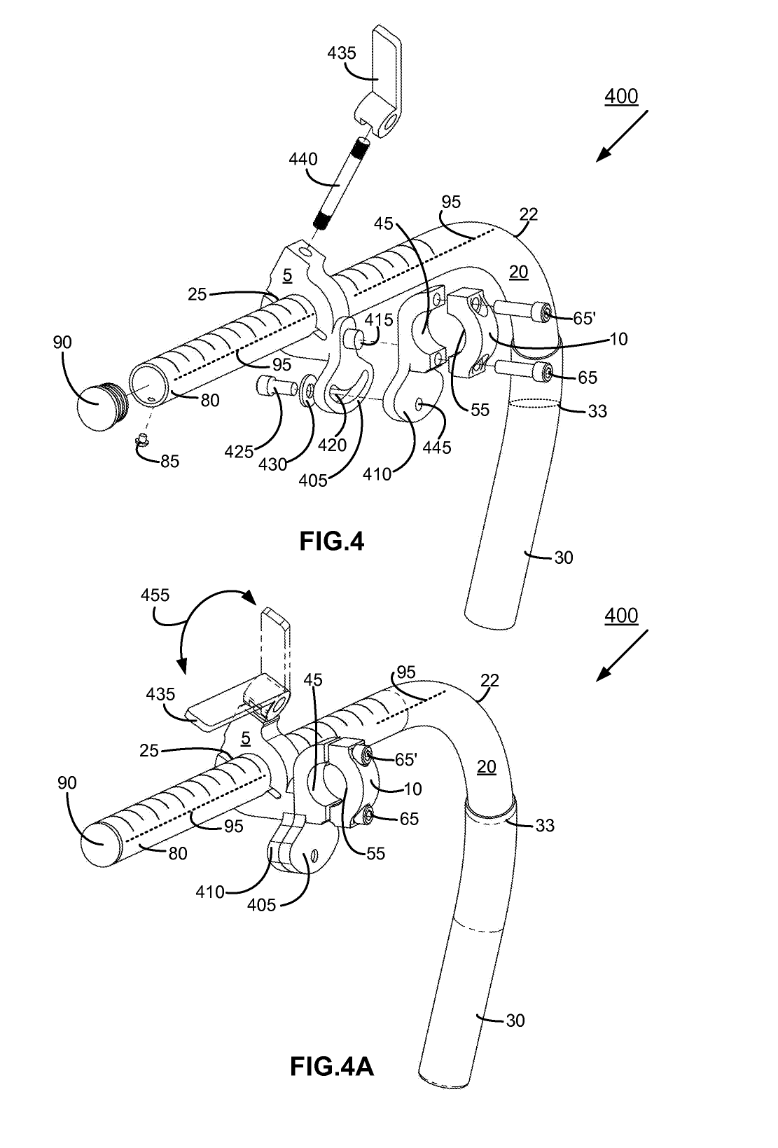

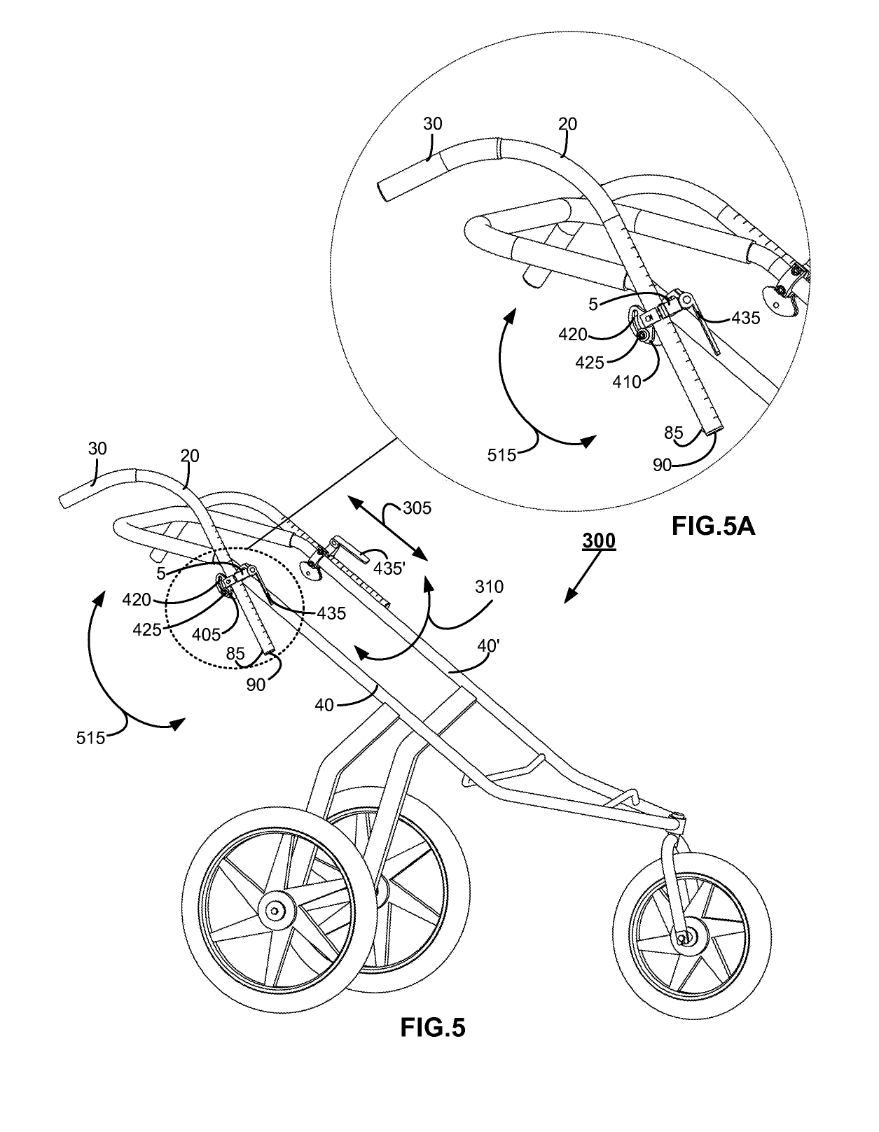

Referring to FIG. 4, an exploded prospective view of an extensible handle 400 in accordance with another exemplary embodiment is depicted. In this exemplary embodiment, the main body 5 of the clamping assembly 50 (FIG. 2) is divided into two complementary sections 405, 410. The first section 405 of the main body 5 is provided with an axle 415 aligned perpendicular to a long dimension of the L-shaped tubular member 20. The axle 415 facilitates pivoting of the L-shaped tubular member 20 about a longitudinal axis of the cart member 40 (FIG. 5). The first section 405 of the main body 5 is configured as flange aligned perpendicular to the axle 415. The first section 405 member 405 of the main body 5 includes an annular elongated slot 420 extending through a predominate face in which a fastener 425 is axially inserted. When tightened, the fastener 425 may be maintained in a particular pivoted position with a lock washer 430. The second section 410 of the main body 5 includes an aperture dimensioned to receive the axle 415 (not shown) and the main body half of the second aperture 45 (FIG. 2) which receives the cart member 40 (FIG. 5). The second section 410 of the main body 5 is likewise configured as a flange complementary to the first section 405 of the main body 5. The second section 410 of the main body 5 includes a threaded aperture 445 for receiving the fastener 425. Other aspects of the pivoting main body 5 remain unchanged from previously discussed arrangements are not repeated here.

In another exemplary embodiment, the hand bolt 35 (FIG. 2) is replaced with a lever assembly 435, 440. The lever assembly 435, 440 operates as a quick release mechanism which allows rapid axial and/or longitudinal adjustment of the L-shaped tubular member 20. The lever assembly 435, 440 is comprised of a lever 435 and threaded shank 440. The lever 435 is configured to engage an outer surface of the main body 5 which pulls the shank 440 threaded into the main body 5 thus causing the opposing hemispherical walls 26, 27 (FIG. 2) to compressively engage an outer circumferential wall of the L-shaped tubular member 20 analogous to the hand bolt (FIG. 2). The lever assembly 435, 440 may be used with any exemplary embodiment described herein.

FIG. 4A depicts an assembled prospective view of the extensible handle 400 in accordance with an exemplary embodiment. In this exemplary embodiment, the lever 435 is disposed in a locked position 455. The first 405 and second 410 sections of the main body 5 are abutted together in a predominate face-to-face relationship which allows the retaining bolt 425 (FIG. 4) to maintain the L-shaped tubular member 20 in a particular axial alignment with respect to the longitudinal section of a cart member 40 (FIG. 5).

Referring to FIG. 5, a perspective view of a pivotal extensible handle 400 (FIG. 4A) attached to a cart 300 in accordance with an exemplary embodiment is depicted. In this exemplary embodiment, a pair of pivotal extensible handles 400 (FIG. 4A) are shown attached to contralateral longitudinal sections of the cart members 40, 40′. Once attached to the longitudinal sections of the cart members 40, 40′, the longitudinal dimensions 305, axial positions 310 and/or pivotal alignments 515 of the pivotal extensible handles 400 may be adjusted by simply loosening the lever assemblies 435, 435′ and positioning of the pivotal extensible handles 400 in a comfortable geometry for the user. Once a comfortable axial 310, longitudinal 305 and/or pivotal positioning 515 geometry has been established, the lever assemblies 435, 435′ are engaged, thus locking the pivotal extensible handles 400 into the comfortable geometry. Alternately, in exemplary embodiments in which the hand bolt 35 (FIG. 2) is employed, the hand bolt 35 FIG. 2) is tightened, thus maintaining the comfortable geometry.

Referring to FIG. 5A, a close-up perspective view of a pivotal extensible handle 400 (FIG. 4A) attached to a cart 300 in accordance with an exemplary embodiment is depicted. In this exemplary embodiment, adjustment of the pivotal extensible handle 400 is accomplished by loosening the retaining bolt 425, orienting the L-shaped tubular member 20 into a comfortable geometry and re-tightening of the retaining bolt 425. Axial 310 and or longitudinal adjustments 305 of the L-shaped tubular member 20 may accomplished at the same time as described above.

The various exemplary inventive embodiments described herein are intended to be merely illustrative of the principles underlying the inventive concept. It is therefore contemplated that various modifications of the disclosed embodiments will, without departing from the inventive spirit and scope, be apparent to persons of ordinary skill in the art. They are not intended to limit the various exemplary inventive embodiments to any precise form described. In particular, it is contemplated that the extensible handle and related components may be constructed from any suitable material. No specific limitation is intended to a particular construction material, order or sequence described. Other variations and inventive embodiments are possible in light of above teachings, and it is not intended that this Detailed Description limit the inventive scope, but rather by the Claims following herein.

1. An extensible handle comprising:
an L-shaped tubular member having a generally arcuate elbow;
a clamping assembly comprising:
a main body;
first and second individual clamping members disposed in a side-by-side relationship at opposing ends of the main body;
the first clamping member including a first aperture formed from opposing hemispherical walls of the main body; the first aperture dimensioned to axially receive the tubular member therethrough;
the first clamping member configured to compressively engage an outer circumferential wall of the tubular member by reduction in a cross-sectional area of the first aperture;
the second clamping member including a second aperture formed by a pair of split opposing walls of the main body; the second aperture dimensioned to axially receive a longitudinal section of a cart member therethrough;
the second clamping member configured to compressively engage the longitudinal section of the cart member by reduction in a cross-sectional area of the second aperture encompassing the longitudinal section of the cart member.

2. The extensible handle of claim 1 further comprising:
a hand bolt rotationally engaged with the opposing hemispherical walls of the main body and configured to reduce the cross-sectional area of the first aperture by manual tightening of the hand bolt.

3. The extensible handle of claim 2 wherein the hand bolt engages the first clamping member at an oblique angle relative to the main body of the clamping assembly.

4. The extensible handle of claim 1 wherein one of the split opposing walls of the main body is configured as clamp cap separate from the main body and attachable thereto with at least one fastener.

5. The extensible handle of claim 1 wherein the L-shaped tubular member includes a handle section and a positioning section.

6. The extensible handle of claim 5 wherein at least a portion of the handle section is encompassed in a padding material.

7. The extensible handle of claim 5 wherein at least a portion of positioning section includes index markings.

8. The extensible handle of claim 5 wherein the positioning section includes an end of travel stop.

9. The extensible handle of claim 1 wherein the L-shaped tubular member is axially repositionable with the first clamping member.

10. The extensible handle of claim 1 wherein the L-shaped tubular member is longitudinally repositionable with the first clamping member.

11. An extensible handle comprising:
an L-shaped tubular member having a generally arcuate elbow;
a clamping assembly comprising:
a main body;
first and second individual clamping members disposed in a side-by-side relationship at opposing ends of the main body;
the first clamping member arranged in a C-shape and includes a first aperture formed from opposing hemispherical walls of the main body; the first aperture dimensioned to axially receive the tubular member therethrough;
the first aperture configured to compressively engage an outer circumferential wall of the tubular member by reduction in a cross-sectional area of the first aperture;
the second clamping member including a second aperture formed by a pair of split opposing walls of the main body; the second aperture dimensioned to axially receive a longitudinal section of a cart member therethrough;
the second clamping member configured to compressively engage the longitudinal section of the cart member by reduction in a cross-sectional area of the second aperture encompassing the longitudinal section of the cart member.

12. The extensible handle of claim 11 further comprising:
compressing means for reducing the cross-sectional area of the first aperture.

13. The extensible handle of claim 12 wherein the compressing means is one of a hand bolt and a lever assembly.

14. The extensible handle of claim 11 wherein the L-shaped tubular member is axially repositionable with the C-shaped clamping member.

15. The extensible handle of claim 11 wherein the L-shaped tubular member is longitudinally repositionable with the C-shaped clamping member.

16. An extensible handle comprising:
an L-shaped tubular member having a generally arcuate elbow;
a clamping assembly comprising:
a main body including an intermediate pivotal axle;
first and second individual clamping members disposed in a side-by-side relationship at opposing ends of the main body;
the first clamping member including a first aperture formed from opposing hemispherical walls of the main body; the first aperture dimensioned to axially receive the tubular member therethrough;
the first clamping member configured to compressively engage an outer circumferential wall of the tubular member by reduction in a cross-sectional area of the first aperture;
the second clamping member including a second aperture formed by a pair of split opposing walls of the main body; the second aperture dimensioned to axially receive a longitudinal section of a cart member therethrough;
the second clamping member configured to compressively engage the longitudinal section of the cart member by reduction in a cross-sectional area of the second aperture encompassing the longitudinal section of the cart member.

17. The extensible handle of claim 16 further comprising:
compressing means for reducing the cross-sectional area of the opposing hemispherical walls.

18. The extensible handle of claim 16 wherein the L-shaped tubular member is both axially and longitudinally repositionable with the first clamping member.

19. The extensible handle of claim 16 wherein the intermediate pivotal axle is configured to pivot at oblique angles relative to the longitudinal section of a cart member.

20. The extensible handle of claim 16 wherein the L-shaped tubular member includes a handle section and a positioning section;
the handle section being encompassed in a padding material and the positioning section provided with index markings.
